(19) United States
(12) Patent Application Publication
(10) Pub. No.: US 2015/0217367 A1
(43) Pub. Date: Aug. 6, 2015

(54) Three-Dimensional Printing of Metallic Materials

(71) Applicant: North Carolina State University, Raleigh, NC (US)

(72) Inventors: Michael D. Dickey, Raleigh, NC (US); Mohammed Mohammed, Raleigh, NC (US); Collin Ladd, North Charleston, SC (US); Elsie Bjarnason, Roanoke Rapids, NC (US)

(21) Appl. No.: 14/613,019

(22) Filed: Feb. 3, 2015

Related U.S. Application Data
(60) Provisional application No. 61/935,087, filed on Feb. 3, 2014.

(51) Int. Cl. B22D 23/00; B22D 18/08; B22D 18/00; B22D 21/00

(52) U.S. Cl. CPC B22D 23/003; B22D 21/00; B22D 18/08; B22D 18/00; B33Y 10/00

(57) ABSTRACT

Methods of printing metallic objects include providing parameters of an object for printing, and controlling a deposition of a fluid metallic material to form the object. At least an outer surface region of the fluid metallic material is converted to a solid region after deposition.

### RELATED APPLICATIONS

This application claims priority to U.S. Provisional Application Ser. No. 61/935,087, filed Feb. 3, 2014, the disclosure of which is hereby incorporated by reference in its entirety.

### FIELD OF THE INVENTION

The present invention relates to three-dimensional printing, and in particular, the three-dimensional printing of metallic materials.

### BACKGROUND

Recently, there has been growing commercial interest in three-dimensional (3D) printing tools (also known as additive manufacturing) for rapid prototyping, although these tools focus primarily on plastics. Additive manufacturing tools pattern “pixels” of materials in a layer by layer fashion to create three-dimensional (3D) objects. The appeal of 3D Printing is that it can rapidly prototype objects that are conceptualized on a computer. Likewise, it can create replicas of objects that are 3D scanned into a computer. There are many examples including the popular Makerbot™ (New York, N.Y.), which extrudes molten polymers in a layer-by-layer fashion until a 3D part is complete.

Most 3D printers work with plastics only. Metal parts may be 3D printed by selectively sintering layers of metal dust one layer at a time, but this method requires expensive laser writers or electron-beam systems to induce large local temperature excursions to fuse the metallic ‘dust’ (which is messy) to produce parts that have poor resolution. These instruments are expensive and difficult to operate. A similar approach to 3D printing metals is to pattern organic materials (e.g., polymers) containing metal particles and then later bake out the organic binder and thus, sinter the particles. Both of these processes have common features: they require high temperatures and produce rough parts with poor resolution.

Recently, there have been developments in metals processing that allow for the rapid fabrication of metal parts on both the macro and nanoscale. The process works by imprinting or molding amorphous metal alloys. These processes are capable of replicating both macro and nano-scale features. Although the processes require relatively ‘low’ temperatures compared to conventional metal processing, they still require hundreds of degrees and are generally not considered 3D printing. There has also been recent developments for patterning metal nanostructures using metal-organic ink precursors that can be converted to metal and by directly embossing metal films supported by soft polymer substrates; however, these processes do not generally have the flexibility and other advantages of 3D printing. There have also been developments printing colloidal dispersions of metal particles in solvents, such as water. The solvent evaporates during printing, which leaves behind the particles of metal that can ultimately be sintered using heat or light.

### SUMMARY OF EMBODIMENTS OF THE INVENTION

In some embodiments, methods of printing metallic objects include providing parameters of an object for printing, and controlling a deposition of a fluid metallic material to form the object. At least an outer surface region of the fluid metallic material is converted to a solid region after deposition.

In some embodiments, controlling a deposition of the fluid metallic material comprises controlling a pressure and/or flow rate of the material while simultaneously controlling a deposition location of the material such that deposited material forms the object. Controlling a deposition of the fluid metallic material may include depositing a first portion of the material, and then depositing a second portion of the material on the first portion after an outer surface region of the first portion is converted to a solid region. Controlling a deposition of the fluid metallic material may include depositing a stream of the fluid metallic material from a nozzle. The object may include an electrical connection on a substrate formed by the stream of the fluid metallic material. In some embodiments, controlling the flow rate while simultaneously controlling a deposition location of the material includes depositing globules of the fluid metallic material to thereby form a three-dimensional structure. Depositing globules of the fluid metallic material may include depositing stacks of connected globules that together form a three-dimensional object. The globules may be about 1 micron to 1 mm in diameter.

In some embodiments, the solid region comprises an oxidized region of the fluid metallic material.

In some embodiments, the fluid metallic material is a fluid at or below temperatures of about 60° C.

In some embodiments, the fluid metallic material is selected from the group consisting of gallium, mercury or alloys thereof.

In some embodiments, the object comprises a three-dimensional metallic structure, and the method further comprising depositing a three-dimensional polymeric structure adjacent the metallic three-dimensional structure.

In some embodiments, the fluid metallic material is deposited with a deposition system having a fluid metallic material reservoir and an outlet for dispensing the fluid metallic material.

In some embodiments, the fluid metallic material comprises an amalgam, and the material is deposited using a mixing element.

In some embodiments, a system for printing metallic objects includes a deposition system having a fluid metallic material reservoir and an outlet for dispensing a fluid metallic material; and a controller configured to control a deposition of the fluid metallic material by the deposition system so as to form a solid structure such that at least an outer surface region of the fluid metallic material is converted to a solid region after deposition.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a fluid metallic dispensing system according to some embodiments.

FIG. 2 is an image of metal wires extruded from a syringe according to some embodiments.

FIGS. 3A-3G are images of metallic structures formed using methods according to some embodiments.

FIG. 4A is a graph of the tensile force as a function of wire circumference for metal wires according to some embodiments.

FIG. 4B is an image of wires formed at various pressures according to some embodiments.

FIGS. 5A-5D are images of a wire formed on a flexible structure according to some embodiments.

FIG. 6 is an image of a molded amalgam according to some embodiments.

FIG. 7 is a system diagram illustrating methods, systems and computer program products according to some embodiments.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor or circuit(s) of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

In some embodiments, a fluid metallic material is deposited to form a three-dimensional structure. At least an outer surface region of the fluid metallic material is converted to a solid region after deposition.

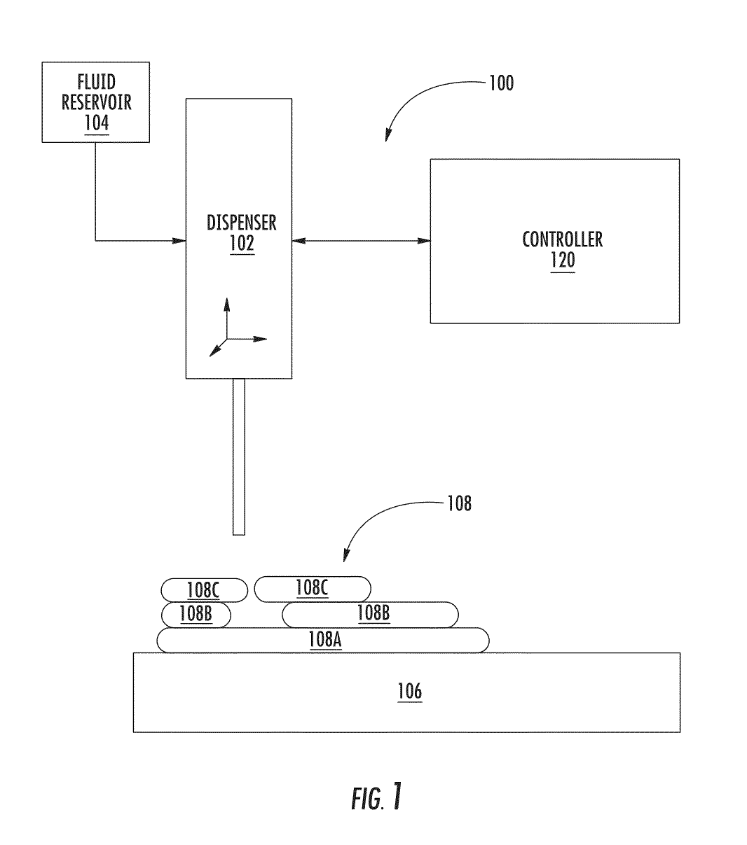

As illustrated in FIG. 1, a three-dimensional (3D) printing system 100 is shown. The 3D printing system 100 includes a fluid dispenser 102 that is connected to a fluid reservoir 104 having a fluid therein. The system 100 also includes a deposition substrate 106, and a 3D metallic object 108 may be deposited on the substrate 106 by the dispenser 102 in a plurality of layers 108A-108C. A controller 120 controls the movement of the dispenser 102 relative to the substrate 106 in the x-y-z plane to dispense the material 108 in a two- or three-dimensional shape.

Although embodiments according to the present invention are illustrated with respect to the system 100, it should be understood that other configurations may be used. For example, although the controller 120 is depicted as controlling movement of the dispenser 102, in some embodiments, the dispenser 102 may be stationary, and the substrate 106 may be moved by the controller 120 relative to the dispenser 102 in order to dispense a 3D object 108. Moreover, additional fluid reservoirs including different or similar fluids may be used. In some embodiments, more than one dispenser 102 may be employed to deposit the same or different fluids from one or more reservoirs. For example, in some embodiments, the dispenser 102 may be used to deposit a metallic material as described herein, and another dispenser (not shown) may be used to deposit a polymeric or other material, such as an insulating material, e.g., to create scaffold or support for the metallic material. Such dispensers may be connected to one another and move simultaneously with one another or may be separately controllable.

In some embodiments, the dispenser 102 is a syringe with a pressure control that controls the rate and/or amount of material that is dispensed. The syringe may extrude liquid metal from a needle that is simultaneously withdrawn from the substrate. The metal may be stabilized mechanically by a thin (e.g., about 1 nm thick) oxide layer or skin that forms rapidly and spontaneously on its surface. In particular embodiments, the size and/or shape of the dispensed material may be controlled by controlling the amount of material being dispensed (which may be controlled by volumetric displacement or by controlling the pressure with which the material is dispensed over a given amount of time), the rate at which it is dispensed, the movement of the dispenser 102 during deposition, and the properties of the material itself. Any suitable dispenser may be used, including an ink jet dispenser. Thus, the controller 120 may be configured to control the amount and/or rate of material being dispensed by the dispenser 102 and/or the movement of the dispenser 102 relative to the substrate 106. In some embodiments, the controller 120 may further control two or more dispensers or dispensing nozzles and/or a fluid flow from two or more fluid reservoirs to control a deposition of more than one type of fluid material. In some embodiments, multiple dispensers may be used, e.g., to increase a speed of formation.

In some embodiments, the fluid reservoir 104 includes a fluid metallic material. The fluid metallic material may be heated above room temperature; however, metallic materials that are fluid at room temperature, such as gallium, mercury, or fluid metal alloys thereof, may be used.

FIG. 2 illustrates a series of four images in which a syringe is withdrawn from a substrate while simultaneously extruding liquid metal, such as gallium or mercury. An oxide skin forms on the surface of the metal to stabilize the liquid metal and form an elongated metal structure. In some embodiments, elongated metal structures formed as shown in FIG. 2 may be connected to electrical contacts to form a metal wire, e.g., in an electrical circuit. As a non-limiting example, freestanding wires of at least one centimeter with a diameter of about 200 μm have been formed. The diameter of the nozzle may determine the diameter of the wire. Wires having a diameter of 30 μm-200 μm have been formed with a draw rate of about 2-200 μm/second.

The process of forming the wires in FIG. 2 involves forming a bead of the metal on the tip of the syringe. Although the metal is under pressure, it does not flow out of the syringe due to the stabilizing influence of the oxide skin. Without increasing or decreasing the pressure in the syringe, wires form when the metal contacts a surface, such as the substrate, and the tip of the syringe withdraws away. Because the oxide skin spans from the nozzle of the syringe to the substrate, increasing the distance between the nozzle and the substrate generates a tensile force along the axis of the wire that yields the skin and allows the wire to elongate. The pressure of the liquid metal retards any destabilizing capillary forces long enough for new skin to form and thereby mechanically stabilizes the wire.

The tensile force required to stretch the wire was measured. An extruded straight wire was modeled as a cylinder coated with a thin radially symmetric shell of oxide with uniform thickness. The tensile stress within the oxide shell can be approximated using Equation 1 below, where F is the applied force, r is the minimum radius of the extruded wire, and σ is the tensile surface yield stress.

F=2πrσ Eq. 1

The deflection of a calibrated cantilever (e.g., a 32 gauge needle) measured the tensile force of the wire. The force was calibrated by measuring the deflection imposed by droplets of various sizes at the end of the cantilever and then the deflection of the needle was measured while stretching wires. FIG. 4A illustrates the force as a function of minimum circumference of the wire. The slope of the fitted line is 0.77 N/m, which is similar to previously reported values of the critical surface yield stress of the oxide (about 0.5 N/m) measured in shear. This value may also include the effects of surface tension associated with increasing the surface area of the liquid. Increasing the distance between the stage and the syringe generates the tensile force for elongating the wire.

Accordingly, to form the wires of FIG. 2, the oxide skin generally yields in tensile mode for the wire to elongate, the liquid metal is under pressure to reduce or prevent the liquid from collapsing during elongation, and the pressure inside the wire should not be too large such that the fiber may bulge radially. A range of pressures over which the metal necks, bulges or forms stable wires was determined. FIG. 4B illustrates the mechanical stability of the liquid metal wires as a function of the applied pressure (circles: necking, rectangles: stable wires, triangles: bulging). The inset images show a glass capillary forming wires that are necked, stabilized and bulged. At low pressures, the wires neck and at larger pressures the wires bulge. The wires begin to bulge at pressures of about 5 kPa or the yield stress value of the oxide skin for the radius of fabricated wires. Minimum positive pressure may be used, which implies that the oxide skin reforms rapidly and stabilizes the wire against capillary forces. It should be understood that these exemplary parameters may be specific to a particular system and set of wires, and that other parameters may be used with respect to other systems. Moreover, wires may be formed that are normal to an underlying substrate or in plane (parallel) to the substrate surface. Wire connections may also be made that extend at an angle, for example, to connect electrical components at different heights.

In addition to extruding wires, free-standing liquid metal structures and microstructures may be formed by 1) expelling the metal rapidly to form a stable liquid metal filament, 2) stacking droplets, and 3) injecting the metal into microchannels and, optionally, subsequently removing the channels chemically. For example, metal may be injected or deposited into channels, such as 3D printed polymeric channels. The channels may be dissolved or removed chemically while the metal remains intact.

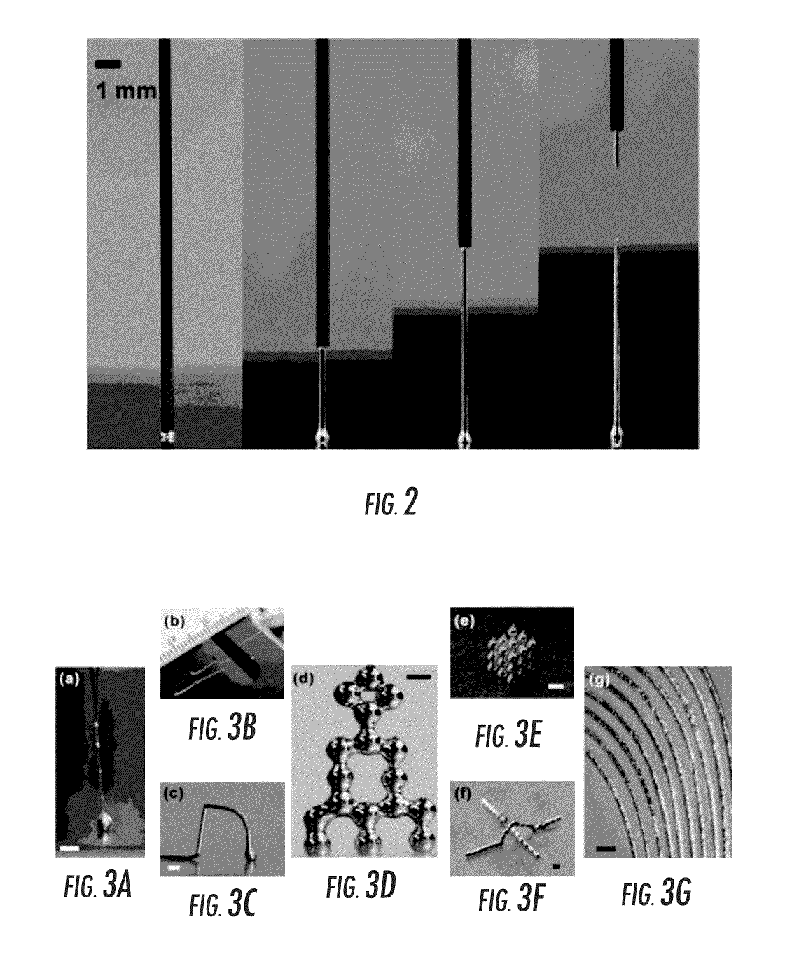

FIGS. 3A-3G illustrates images of free-standing, liquid metal structures that may be direct write patterned as described herein. A metal fiber formed by rapid extrusion of the liquid metal from a syringe is shown in FIGS. 3A-3C. FIGS. 3A-3B are formed by rapidly expelling the metal from the syringe using bursts of pressure (about 60 kPa of pressure for tens of milliseconds). It should be understood that any suitable pressure and timing of the bursts may be used. Fibers also form at larger pressures, but may risk a rupture when they reach the substrate. In FIG. 3A, the fiber spans from a tip of a needle of a microsyringe to the substrate, and as shown in FIG. 3B, the fiber is strong enough to be suspended over a gap. As shown in FIG. 3C, an arch structure may be formed. Such an arch structure could be used, for example, as a wirebond in an electrical circuit. The fibers in FIG. 3A naturally form a bead upon hitting the surface, which may be useful for forming contact pads.

The structure in FIG. 3C forms in a manner similar to that shown in FIG. 2, but is bent into an arch using the motion of the substrate or stage. This process may be used to fabricate 3D microstructures of liquid metal, such as wires, arches and bridges.

In some embodiments, droplets or globules may be deposited in succession to form a three dimensional layer. FIGS. 3D-3F illustrate a stack of globules that may be used to print a 3D structure. As shown in FIG. 3F, an arch structure may be formed. FIG. 3G illustrates an array of lines that may be deposited using a dispenser as described herein. The droplets form using short bursts of pressure (e.g., 20-60 kPa for 1-2 msec) and remain suspended from the tip of the syringe (e.g., under back pressure) until they contact another droplet. When the droplets touch each other, they merge to form a physical and electrical contact without coalescing into one bigger droplet.

Chemically etching the microfluidic molds after injection of the liquid metal offers another way of fabricating free standing conductive microstructures. After injecting the liquid metal into a 10-turn, coil shaped polydimethylsiloxane (PDMS) microchannel that is 200 μm wide and tall, a solution of 1.0 M tetrabutylammonium fluoride (TBAF)/dimethylformamide (DMF) removed the PDMS via chemical etching as shown in FIG. 3G. The patterned metal lines that remain maintain mechanical stability due to the oxide skin even after removing the polymer casing. Accordingly, encasing the freestanding liquid metal structures with other materials, such as polymers, elastomers, and ceramics may be used.

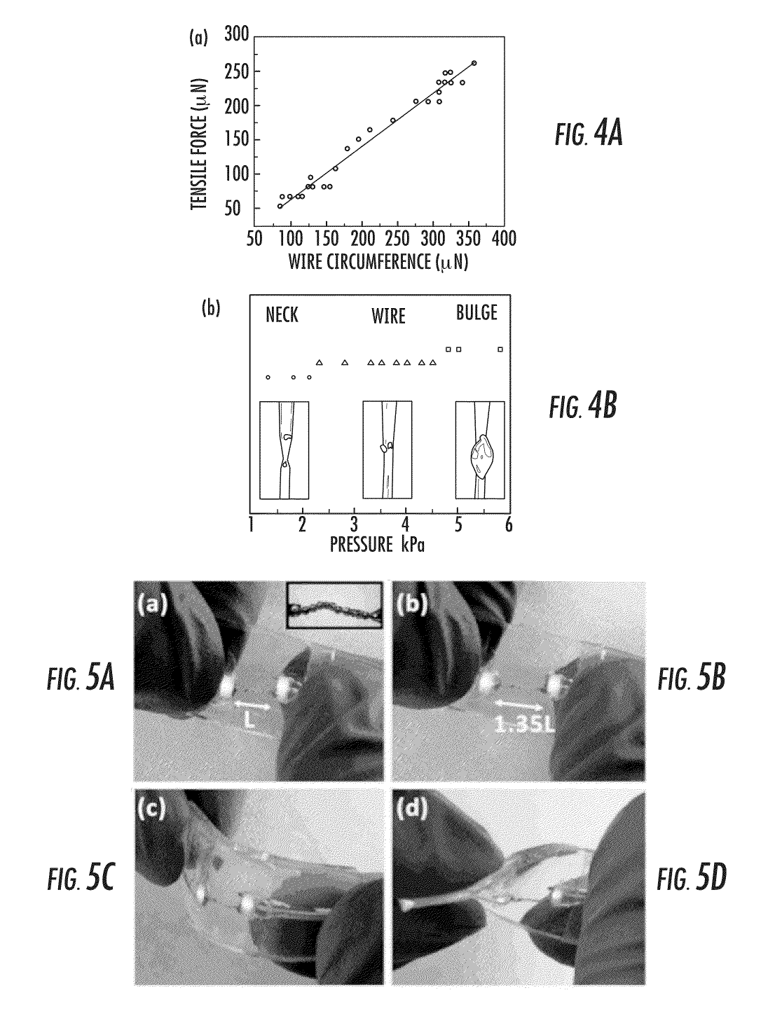

FIGS. 5A-5D illustrate the application of liquid metal wires for stretchable electronics, which may function while being elongated and/or bent. The wires are embedded in PDMS, and a micrographs of the wire (FIG. 5A, insert) shows a wire bond composed of liquid metal droplets connecting two surface mounted LEDs separated by 5 mm. The liquid metal bridge connecting the LEDs functions up to the strain limit of PDMS (FIG. 5B, about 35% strain) while being flexed (FIGS. 5C-5D) without losing its electrical continuity. It should be understood that other types of encasing materials may be used, such as castable plastics, ceramics, resins and gels. Moreover, in some embodiments, a non-metallic structure, such as a conventional polymeric 3D printed structure, may be formed together with the metallic structure.

In some embodiments, the fluid metallic material in the reservoir 104 may include solid metal particles, such as copper, silver, chromium, gold, platinum, iron, and/or nickel, that is mixed with gallium and/or mercury, for example, having a diameter of between 1 nm and 100 microns. Such metallic materials may be referred to as amalgams, and may have a consistency of a metal paste. Such amalgams may form an entirely solid structure over time after deposition. For example, gallium may interdiffuse with the metal particles (e.g., metal nano- or micro-particles) over time and form a rigid, hard, solid metal structure. In some embodiments, a small amount of heat may be added to the amalgams to form a liquid during deposition. For example, the amalgam material may be kept at or slightly above ambient room temperature up to about 60 to 70 or 80 degrees Centigrade or more. The material properties of the material may be controlled using variables such as composition, electric potential, temperature, pressure and temperature.

The metal material shown in FIGS. 3A-3G is a liquid metal alloy of gallium, which has a relatively low viscosity (about twice that of water) and may be shaped and manipulated at room temperature and then subsequently hardened via a kinetic formation of a new alloy. A thin oxide layer on the surface of the metal may allow for the formation of mechanically stable structures strong enough to stand against gravity and the surface tension of the liquid. Without wishing to be bound by any particular theory, an oxide may form on the outside of the metal to help hold the liquid metal structure together. The metal may then become a solid, for example, by the diffusion of the liquid into the solid and/or the solid into the liquid to form a new alloy. The metal may also be formed as a solid by cooling the metal to below a freezing point of the material after deposition.

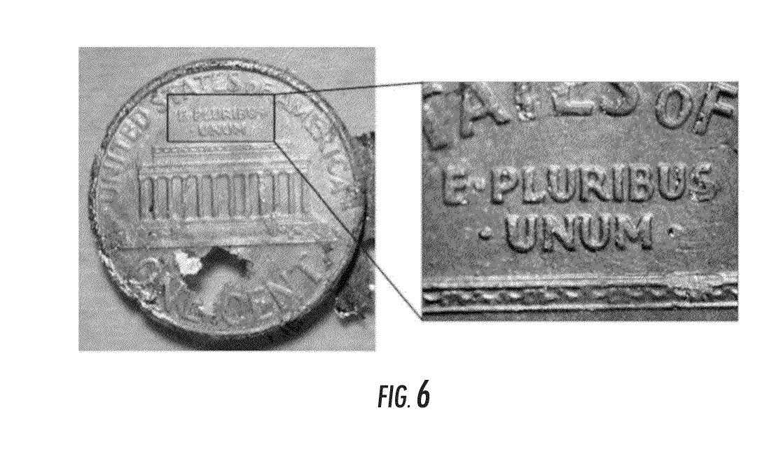

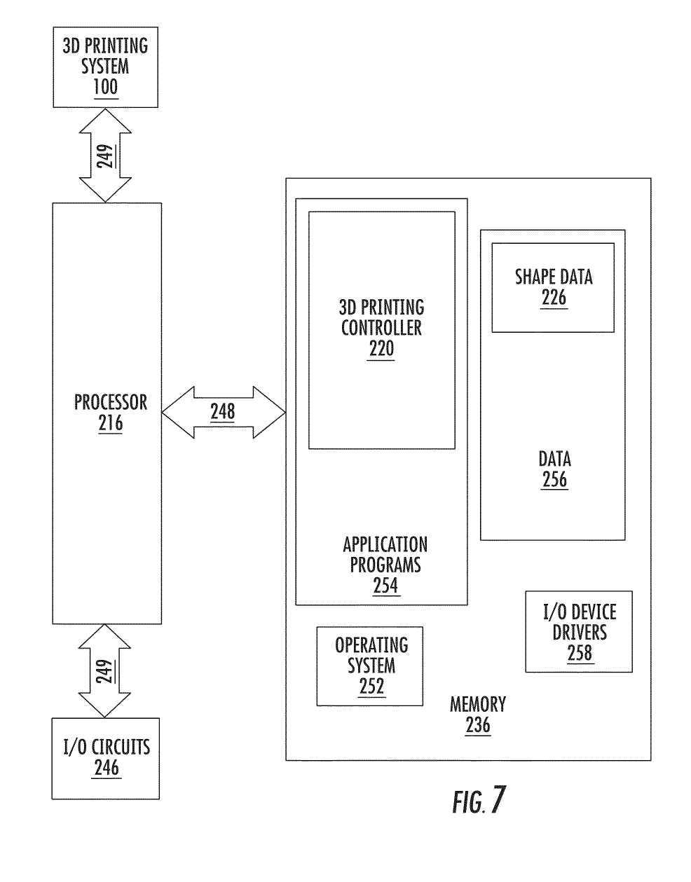

FIG. 6 illustrates a molded amalgam that includes gallium mixed with silver particles that solidify after molding. As can be seen in FIG. 6, good resolution of the amalgam material may be achieved. In some embodiments, amalgam materials may be printed in three dimensions as described herein. In particular embodiments, the amalgam materials may be deposited by a volumetric displacement of the material to physically push out a desired amount of material onto a substrate. Layer-by-layer deposition of amalgam materials may be used to form a 3D printed object as described herein.

Amalgam materials are typically formed of a metal powder that is mixed with a liquid. Examples of suitable powders and liquids include copper, silver, chromium, gold, platinum, iron and/or nickel powders that are mixed with liquid gallium and/or mercury. In particular embodiments, the amalgam may be formed during deposition. For example, a metal powder may be deposited on a substrate followed by the liquid component of the amalgam, which then forms a solid amalgam due to the mixture of the metal powder and liquid component and air exposure. The excess metal powder may be removed. Additional metal powder may be added to the substrate during layer-by-layer deposition of the liquid component in order to form a 3D object.

In some embodiments, the deposition system may use a mixer, such as an auger (a rod or helical-shaped elongated element) that is positioned in a dispenser needle or reservoir for maintaining a mixture of the metal particles within the liquid material during deposition. A mixing element, such as an auger, may be used to reduce or eliminate separation issues during deposition.

FIG. 7 illustrates an exemplary data processing system that may be included in devices operating in accordance with some embodiments of the present invention, e.g., to control the 3D printer system 100 in FIG. 1. As illustrated in FIG. 7, a data processing system 200, which can be used to carry out or direct operations includes a processor 216, a memory 236 and input/output circuits 246. The data processing system 200 can be incorporated in a portable communication device and/or other components of a network, such as a server. The processor 216 communicates with the memory 236 via an address/data bus 248 and communicates with the input/output circuits 246 and/or the 3D Printing System 100 via an address/data bus 249. The input/output circuits 246 can be used to transfer information between the memory (memory and/or storage media) 236 and another component, such as the 3D Printing System 100. These components can be conventional components such as those used in many conventional data processing systems, which can be configured to operate as described herein.

In particular, the processor 216 can be a commercially available or custom microprocessor, microcontroller, digital signal processor or the like. The memory 236 can include any memory devices and/or storage media containing the software and data used to implement the functionality circuits or modules used in accordance with embodiments of the present invention. The memory 236 can include, but is not limited to, the following types of devices: cache, ROM, PROM, EPROM, EEPROM, flash memory, SRAM, DRAM and magnetic disk. In some embodiments of the present invention, the memory 236 can be a content addressable memory (CAM).

As further illustrated in FIG. 7, the memory (and/or storage media) 236 can include several categories of software and data used in the data processing system: an operating system 252; application programs 254; input/output device circuits 246; and data 256. As will be appreciated by those of skill in the art, the operating system 252 can be any operating system suitable for use with a data processing system, such as IBM®, OS/2®, AIX® or zOS® operating systems or Microsoft® Windows® operating systems Unix or Linux™. The input/output device circuits 246 typically include software routines accessed through the operating system 252 by the application program 254 to communicate with various devices. The application programs 254 are illustrative of the programs that implement the various features of the circuits and modules according to some embodiments of the present invention. Finally, the data 256 represents the static and dynamic data used by the application programs 254, the operating system 252 the input/output device circuits 246 and other software programs that can reside in the memory 236.

The data processing system 200 can include several circuits or modules, including a 3D printer controller 220 and the like. The modules can be configured as a single module or additional modules otherwise configured to implement the operations described herein for controller a 3D printer system 100. The data 256 can include shape data 226 and/or other data that may be used, for example to control the 3D printer system 100. For example, the shape data may include various fluid pressures, movements, etc. for forming a particular shape for an object.

While the present invention is illustrated with reference to the 3D printer controller 220 and the shape data 224 in FIG. 7, as will be appreciated by those of skill in the art, other configurations fall within the scope of the present invention. For example, rather than being an application program 254, these circuits and modules can also be incorporated into the operating system 252 or other such logical division of the data processing system. Furthermore, while the 3D printer controller 220 in FIG. 7 is illustrated in a single data processing system, as will be appreciated by those of skill in the art, such functionality can be distributed across one or more data processing systems and/or may be integrated with the 3D printing system 100. Thus, the present invention should not be construed as limited to the configurations illustrated in FIG. 7, but can be provided by other arrangements and/or divisions of functions between data processing systems. For example, although FIG. 7 is illustrated as having various circuits and modules, one or more of these circuits or modules can be combined, or separated further, without departing from the scope of the present invention.

It should be understood that the metal deposition techniques described above may be used to form interconnects between electrical components on a substrate, wires, antennas, metamaterials, plasmonic structures, electrodes, mirrors, sensors and mechanical reinforcing elements.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of printing metallic objects, the method comprising:
providing parameters of an object for printing; and
controlling a deposition of a fluid metallic material to form the object, wherein at least an outer surface region of the fluid metallic material is converted to a solid region after deposition.

2. The method of claim 1, wherein controlling a deposition of the fluid metallic material comprises controlling a pressure and/or flow rate of the material while simultaneously controlling a deposition location of the material such that deposited material forms the object.

3. The method of claim 2, wherein controlling a deposition of the fluid metallic material comprises depositing a first portion of the material, and then depositing a second portion of the material on the first portion after an outer surface region of the first portion is converted to a solid region.

4. The method of claim 2, wherein controlling a deposition of the fluid metallic material comprises depositing a stream of the fluid metallic material from a nozzle.

5. The method of claim 4, wherein the object comprises an electrical connection on a substrate formed by the stream of the fluid metallic material.

6. The method of claim 2, wherein controlling the flow rate while simultaneously controlling a deposition location of the material comprises depositing globules of the fluid metallic material to thereby form a three-dimensional structure.

7. The method of claim 6, wherein depositing globules of the fluid metallic material comprises depositing stacks of connected globules that together form a three-dimensional object.

8. The method of claim 7, wherein the globules are about 1 micron to 1 mm in diameter.

9. The method of claim 1, wherein the solid region comprises an oxidized region of the fluid metallic material.

10. The method of claim 1, wherein the fluid metallic material is a fluid at or below temperatures of about 60° C.

11. The method of claim 1, wherein the fluid metallic material is selected from the group consisting of gallium, mercury or alloys thereof.

12. The method of claim 1, wherein the object comprises a three-dimensional metallic structure, the method further comprising depositing a three-dimensional polymeric structure adjacent the metallic three-dimensional structure.

13. The method of claim 1, wherein the fluid metallic material is deposited with a deposition system having a fluid metallic material reservoir and an outlet for dispensing the fluid metallic material.

14. The method of claim 1, wherein the fluid metallic material comprises an amalgam, and the material is deposited using a mixing element.

15. A system for printing metallic objects, the system comprising:
a deposition system having a fluid metallic material reservoir and an outlet for dispensing a fluid metallic material; and
a controller configured to control a deposition of the fluid metallic material by the deposition system so as to form a solid structure such that at least an outer surface region of the fluid metallic material is converted to a solid region after deposition.

16. The system of claim 15, wherein the controller is configured to control the deposition of the fluid metallic material by controlling a pressure and/or flow rate of the material while simultaneously controlling a deposition location of the outlet such that deposited material forms the object.

17. The system of claim 16, wherein the controller is configured to control a deposition of the fluid metallic material to deposit a first portion of the material, and then to deposit a second portion of the material on the first portion after an outer surface region of the first portion is converted to a solid region.

18. The system of claim 17, wherein the controller is configured to control a deposition of the fluid metallic material to deposit a stream of the fluid metallic material from a nozzle.

19. The system of claim 18, wherein the object comprises an electrical connection on a substrate formed by the stream of the fluid metallic material.

20. The system of claim 16, wherein the controller is configured to control the flow rate while simultaneously controlling a deposition location of the material to deposit globules of the fluid metallic material to thereby form the three-dimensional structure.

21. The system of claim 20, wherein the controller is configured to deposit globules of the fluid metallic material in stacks of connected globules that together form a three-dimensional object.

22. The system of claim 21, wherein the globules are about 1 micron to 1 mm in diameter.

23. The system of claim 15, wherein the solid region comprises an oxidized region of the fluid metallic material.

24. The system of claim 15, wherein the fluid metallic material is a fluid at or below temperatures of about 60° C.

25. The system of claim 15, wherein the fluid metallic material is selected from the group consisting of gallium, mercury or alloys thereof.

26. The system of claim 15, wherein the object comprises a three-dimensional metallic structure, and the controller is further configured to control a deposition of a three-dimensional polymeric structure adjacent the metallic three-dimensional structure.

27. The system of claim 15, wherein the metallic material comprises an amalgam and the deposition system further comprises a mixing element configured to mix the fluid metallic material prior to deposition.
